(19) United States
(12) Patent Application Publication
(10) Pub. No.: US 2024/0177609 A1
(43) Pub. Date: May 30, 2024

(54) APPARATUS FOR CONTROLLING TRAVELING OF VEHICLES IN ROUNDABOUT

(71) Applicant: Korea Electronics Technology Institute, Seongnam-si (KR)

(72) Inventors: Ki Taeg LIM, Suwon-si (KR); Dae Kyo SHIN, Seongnam-si (KR); Sang Hun YOON, Seongnam-si (KR); Soo Hyun JANG, Yongin-si (KR); Seong Hyun JANG, Yongin-si (KR)

(21) Appl. No.: 18/350,570

(22) Filed: Jul. 11, 2023

(30) Foreign Application Priority Data
Nov. 24, 2022 (KR) 10-2022-0159746
Nov. 24, 2022 (KR) 10-2022-0159749

(51) Int. Cl. G08G 1/16; G08G 1/01

(52) U.S. Cl. CPC G08G 1/166; G08G 1/0112; G08G 1/0116; G08G 1/0145

(57) ABSTRACT

An apparatus for controlling traveling of vehicles in a roundabout is proposed. The apparatus may include an input unit configured to receive classification information on a roundabout which a traveling vehicle approaches and surrounding environment information, and a memory in which a vehicle traveling control program for the roundabout is stored. The apparatus may also include a processor configured to execute the program, in which the processor determines a traveling negotiation target according to the classification information on the roundabout, the surrounding environment information, and route information on the traveling vehicle, and controls a traveling behavior of the vehicle in the roundabout according to a traveling negotiation result.

### CROSS-REFERENCE TO RELATED APPLICATION

This application claims priority to and the benefit of Korean Patent Application Nos. 10-2022-0159746 field on Nov. 24, 2022, and 10-2022-0159749 field on Nov. 24, 2022, the disclosure of which is incorporated herein by reference in its entirety.

### BACKGROUND

### Technical Field

The present disclosure relates to an apparatus for controlling traveling of vehicles in a roundabout.

### Description of the Related Technology

A roundabout is a type of level intersection that allows vehicles to pass through the intersection by turning counterclockwise around a circular traffic island in the center of the intersection and operated on the basis of the principle that an entering vehicle yields to a vehicle traveling in a turn lane inside the intersection.

### SUMMARY

One aspect is an apparatus for controlling traveling of vehicles that enables safe traveling control in a roundabout by performing travel negotiations or depending on travel negotiation coordination results, according to various scenarios in the roundabout traffic situation where vehicles with V2X terminals installed and general vehicles without V2X terminals are mixed.

Another aspect is an apparatus for controlling traveling of vehicles that promotes smooth traffic flow by creating a traveling guide in a roundabout where synergistic delay or congestion occurs and controls a traveling behavior in consideration of VRU safety in a crosswalk placed in the area near a roundabout.

An apparatus for controlling traveling of vehicles in a roundabout according to the present disclosure may include an input unit configured to receive classification information on a roundabout which a traveling vehicle approaches and surrounding environment information; a memory in which a vehicle traveling control program for the roundabout is stored; and a processor configured to execute the program, in which the processor determines a traveling negotiation target according to the classification information on the roundabout, the surrounding environment information, and route information on the traveling vehicle, and controls a traveling behavior of the vehicle in the roundabout according to a traveling negotiation result.

The input unit recognizes the classification information on the roundabout using at least one of communication information with a road side unit (RSU), map information, and camera recognition information.

The input unit obtains an ID given by the RSU, and the ID is used as identification information when the RSU coordinates a traveling negotiation.

The processor determines an entering lane for the roundabout using the classification information on the roundabout and the route information, and transmits a traveling command signal to allow the traveling vehicle to travel in the corresponding entering lane.

In consideration of the surrounding environment information on an object in a crosswalk area placed in a direction in which the traveling vehicle exits from the roundabout, the processor performs a traveling negotiation with a device of the object, or receives a traveling negotiation coordination result of the RSU to control a traveling behavior for passing the crosswalk.

The processor controls the traveling behavior using a traveling negotiation result determined according to a congestion level of the object waiting to cross or crossing the crosswalk area.

The processor controls the traveling behavior using the surrounding environment information on a congestion situation in the roundabout, and controls the traveling behavior for entering the roundabout by performing a traveling negotiation with another vehicle with a collision risk that is equal to or greater than a predetermined value or receiving a traveling negotiation coordination result of the RSU, depending on whether another vehicle has a V2X communication function.

The processor receives location and predicted route information on another vehicle from another vehicle or the RSU and controls the traveling behavior of the traveling vehicle by calculating a collision risk with another vehicle using weights differently set according to the classification of the roundabout.

According to the present disclosure, it is possible to prevent traffic accidents and support safe traveling in a roundabout where autonomous vehicles, connected cars, and general vehicles are mixed and travel.

According to the present disclosure, there is an effect of detecting the traveling situation in real time by predicting the traveling direction in the roundabout and supporting safe vehicle traveling and pedestrian crossing in the roundabout through communication between vehicles, between a vehicle and an RSU, and between a vehicle and a device owned by a VRU using a V2X communication function.

The effects of the present disclosure are not limited to the above-mentioned effect, and other effects, which are not mentioned above, may be clearly understood by those skilled in the art from the following descriptions.

### BRIEF DESCRIPTION OF THE DRAWINGS

FIG. 1 is a view illustrating an apparatus for controlling traveling of vehicles in a roundabout according to an embodiment of the present disclosure.

FIGS. 2A to 2C are views illustrating situations of controlling traveling of a vehicle entering the first lane in a spiral roundabout according to an embodiment of the present disclosure.

FIGS. 3A to 3C are views illustrating situations of controlling traveling of a vehicle entering the second lane in the spiral roundabout according to an embodiment of the present disclosure, and FIG. 3D is a view illustrating a situation of controlling traveling of a vehicle at a lane change suppression type roundabout according to an embodiment of the present disclosure.

FIGS. 4A to 4C are views illustrating situations of controlling traveling of vehicles on the basis of situation information on a crosswalk area in the spiral roundabout according to an embodiment of the present disclosure.

FIGS. 5A to 5E are views illustrating situations of controlling traveling of vehicles in a congestion situation in the spiral roundabout according to an embodiment of the present disclosure.

FIGS. 6A and 6B are views illustrating situations of controlling traveling of a vehicle in the spiral roundabout depending on whether the other vehicle is equipped with a V2X function according to an embodiment of the present disclosure.

FIG. 7 is a flowchart illustrating a method of controlling traveling of a vehicle in a roundabout according to an embodiment of the present disclosure.

FIG. 8 is a block diagram illustrating a computer system for implementing the method according to an embodiment of the present disclosure.

### DETAILED DESCRIPTION

In general, the roundabout has advantages of reducing driver fatigue due to fewer conflicts in traffic, an operation with low speeds, and a driver's simple decision compared to the level intersection, and of lowering maintenance costs, increasing an accessibility to adjacent roads and areas, and reducing a delay time to reduce fuel consumption and emissions, and the like compared to the signalized intersection.

However, there are problems in that some drivers may not be properly aware of the traveling rules in the roundabout, and there is a high risk of accidents in the roundabout in traveling situations where autonomous vehicles (vehicles that travel autonomously based on V2X communication and vehicle sensors), connected cars (general vehicles that are equipped with V2X communication terminals and capable of communicating with surrounding vehicles and infrastructure), and general vehicles (vehicles that are not equipped with autonomous driving functions and V2X communication terminals) are mixed. As an actual example, in the area of the roundabout in front of the Giheung tollgate on the Gyeongbu Expressway, the traffic has rapidly increased as the number of residents in the nearby new town has increased, and the traffic congestion at and around the roundabout became even more serious. Further, since many of the drivers do not know the rules of the roundabout and drive in different ways, the roundabout is not playing its role at all.

In addition, the roundabout design guideline presents design specifications such as a design speed of a rotating part, a length and height of the cross-section of the central traffic island, etc. However, regarding the roundabout in downtown areas, there is a problem in that an operating system that considers the situation of a vulnerable road user (VRU) crossing the surrounding crosswalks has not yet been established.

The above-mentioned object, other objects, advantages, and features of the present disclosure and methods of achieving the objects, advantages, and features will be clear with reference to embodiments described in detail below together with the accompanying drawings.

However, the present disclosure is not limited to the embodiments disclosed herein but will be implemented in various forms, and the following embodiments are provided only to easily inform those skilled in the art to which the present disclosure belongs of the purpose, constitution and effect of the disclosure. The present disclosure will be defined only by the scope of the appended claims.

Meanwhile, the terms used in the present specification are for explaining the embodiments, not for limiting the present disclosure. Unless particularly stated otherwise in the present specification, a singular form also includes a plural form. The terms “comprise (include)” and/or “comprising (including)” used in the specification are intended to specify the presence of the mentioned constituent elements, steps, operations, and/or elements, but do not exclude the presence or addition of one or more other constituent elements, steps, operations, and/or elements.

The present disclosure proposes a technology that prevents traffic accidents and supports safe traveling of vehicles in a situation where autonomous vehicles, connected cars, and general vehicles (vehicles without V2X functions) are mixed and travel in a roundabout. According to the present disclosure, V2X road side units, V2X vehicle terminals, and communication devices of VRUs (pedestrians, bicycles, kickboards, etc.) linked to transportation infrastructures such as cameras and lidar communicate with one another in real time to prevent traffic accidents and support safe traveling.

According to an embodiment of the present disclosure, it is possible to support safe traveling in various types of roundabouts, and transmit warnings of dangerous situations in real time by monitoring situations through real-time communication among autonomous vehicles, connected cars and vulnerable road users (VRUs). In addition, it is possible to support safe traveling and prevent accidents through traveling negotiations between a vehicle that intends to enter a roundabout and a vehicle that is traveling within the roundabout. In addition, it is possible to coordinate traveling by monitoring a traveling situation of a general vehicle that is not equipped with a V2X function.

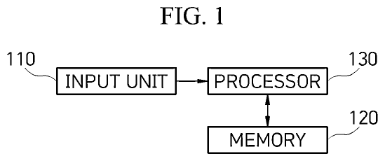

FIG. 1 is a view illustrating an apparatus for controlling traveling of vehicles in a roundabout according to an embodiment of the present disclosure.

An apparatus for controlling traveling of vehicles in a roundabout according to the embodiment of the present disclosure includes an input unit 110 configured to receive classification information on a roundabout which a traveling vehicle approaches; and surrounding environment information; a memory 120 in which a vehicle traveling control program for the roundabout is stored; and a processor 130 configured to execute the program, in which the processor 130 determines a traveling negotiation target according to the classification information on the roundabout, the surrounding environment information, and route information on the traveling vehicle, and controls a traveling behavior of the vehicle in the roundabout according to a traveling negotiation result.

The input unit 110 recognizes the classification information on the roundabout using at least one of communication information with a road side unit (RSU), map information, and camera recognition information.

The input unit 110 obtains an ID given by the RSU, and the ID is used as identification information when the RSU coordinates a traveling negotiation.

The processor 130 determines an entering lane for the roundabout using the classification information on the roundabout and the route information, and transmits a traveling command signal to allow the traveling vehicle to travel to the corresponding entering lane.

In consideration of the surrounding environment information on an object in a crosswalk area placed in a direction in which the traveling vehicle exits from the roundabout, the processor 130 performs a traveling negotiation with a device of the object, or receives a traveling negotiation coordination result of the RSU to control a traveling behavior for passing the crosswalk.

The processor 130 controls a traveling behavior using a traveling negotiation result determined according to the congestion level of the object waiting to cross or crossing the crosswalk area.

The processor 130 controls the traveling behavior using the surrounding environment information on a congestion situation in the roundabout, and controls the traveling behavior for entering the roundabout by performing a traveling negotiation with another vehicle with a collision risk that is equal to or greater than a predetermined value or receiving a traveling negotiation coordination result of the RSU, depending on whether another vehicle has a V2X communication function.

The processor 130 receives location and predicted route information on the other vehicle from the other vehicle or the RSU and controls the traveling behavior of the traveling vehicle by calculating a collision risk with the other vehicle using weights differently set according to the classification of the roundabout.

An apparatus for controlling traveling of vehicles in a roundabout according to another embodiment of the present disclosure includes an input unit (or a receiver) 110 configured to receive traveling information on the other vehicles in a roundabout in a congestion situation, a memory 120 in which a vehicle traveling control program for the roundabout is stored, and a processor 130 configured to execute the program, in which the processor 130 receives a traveling negotiation coordination result from an RSU that has generated a guide different from a basic traveling guide for turning vehicle priority in the congestion situation, and controls a traveling behavior in the roundabout according to the traveling negotiation coordination result.

The input unit 110 receives location and route information on a first vehicle from the first vehicle equipped with a V2X communication function, and receives location and predicted route information on a second vehicle not equipped with the V2X communication function from the first vehicle located in a predetermined area around the second vehicle.

The processor 130 controls the traveling behavior to allow a host vehicle to stop temporarily before entering the roundabout, transmits a traveling negotiation coordination request to the RSU, and the traveling negotiation coordination result is transmitted to the first vehicle.

The traveling negotiation coordination result is displayed through a notification unit placed on a central traffic island, and is provided to a driver of the second vehicle.

The notification unit is located in a predetermined edge area of the central traffic island, and a display surface of the notification unit is driven to rotate according to a location of the second vehicle.

The input unit 110 receives crossing situation information on a crosswalk around the roundabout, and the processor 130 does not transmit the traveling negotiation coordination request to the RSU, and controls the traveling behavior according to the basic traveling guide in case that the processor 130 determines that the congestion situation is temporary due to crossing using the crossing situation information.

According to an apparatus for controlling traveling of vehicles in a roundabout according to still the present embodiment of the present disclosure, the input unit 110 additionally receives route information on a traveling vehicle in the roundabout and vulnerable road user (VRU) information on the crosswalk area placed in the vicinity of the roundabout, and the processor 130 predicts a VRU behavior using VRU recognition information, and controls the traveling behavior of the traveling vehicle in the roundabout according to an predicted result.

The input unit 110 receives the VRU information from at least one of a device of a VRU and the RSU recognizing the VRU, and the VRU information includes behavioral information on crossing or waiting for crossing.

The processor 130 controls the traveling behavior to stop temporarily in front of the crosswalk, and transmits a notification message for the temporary stop through V2V communication.

The processor 130 controls a traveling behavior for notifying the other vehicle of a crossing situation in case of not receiving ACK for the notification message from the other vehicle that is traveling in a lane next to the traveling vehicle and predicted to be traveling in the same direction.

The processor 130 controls the traveling behavior to allow the traveling vehicle to turn a heading angle within a predetermined angle toward a lane closer to the direction of the other vehicle within the traveling lane, or controls a turn signal lighting.

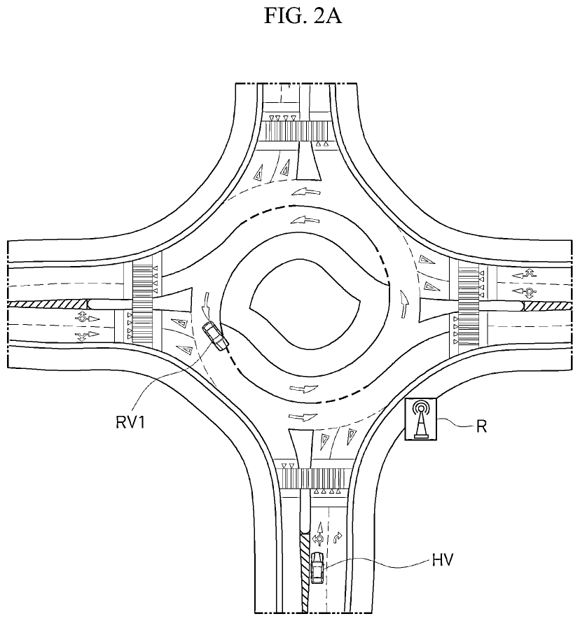

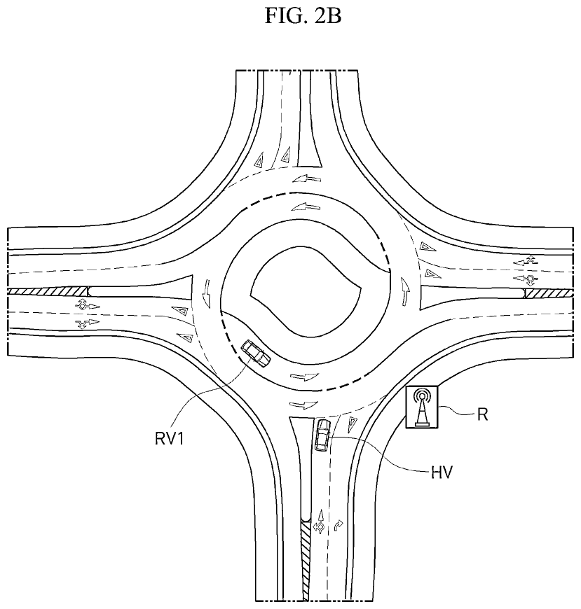

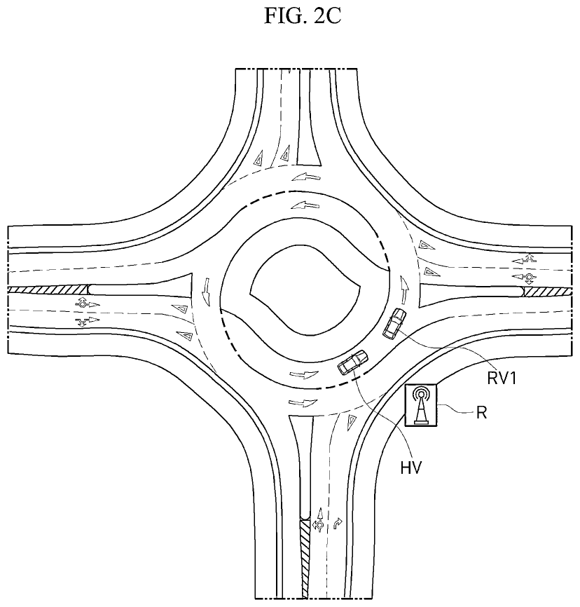

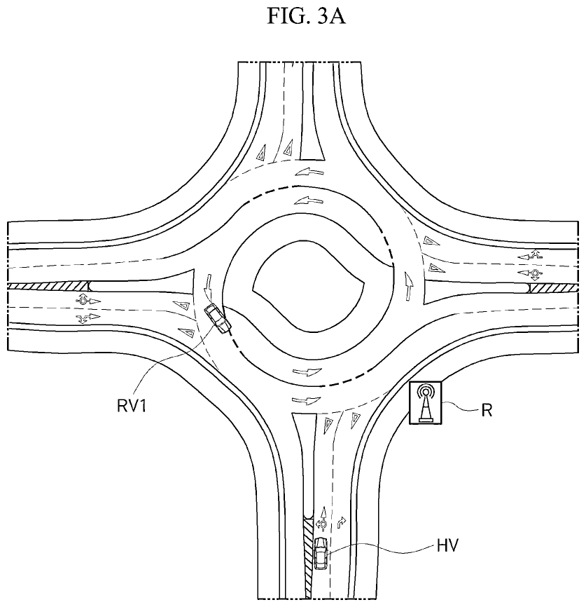

FIGS. 2A to 2C are views illustrating situations of controlling traveling of a vehicle entering the first lane in a spiral roundabout according to an embodiment of the present disclosure.

While FIGS. 2A to 2C illustrate the case that there is no crosswalk in the vicinity of the roundabout, the embodiments described later illustrate the case that there is a crosswalk in the vicinity of the roundabout.

In case that there is a crosswalk in the vicinity of the roundabout, as in the embodiments described later, a vehicle traveling behavior control in the roundabout is performed trough recognition of information on the VRU crossing the street at the crosswalk or waiting to cross the street at the crosswalk and communication between the terminal owned by the VRU and the vehicle terminal, or according to a traveling negotiation command of the RSU.

As another example, a VRU may jaywalk even in case that there is no crosswalk in the vicinity of the roundabout. Therefore, in case that there is a VRU whose location information is verified through video recognition in the vicinity of the roundabout, or in case that route information on a terminal owned by the VRU may be confirmed, the traveling behavior is controlled to prevent an accident with the VRU by confirming whether the VRU is a normal legal pedestrian (i.e., a pedestrian who is unlikely to jaywalk), is jaywalking, or is a pedestrian who is likely to jaywalk and providing information on the corresponding VRU to a vehicle entering the roundabout or traveling in the roundabout.

A traveling vehicle HV is a vehicle that goes straight to enter the roundabout from the 6 o'clock direction and exit from the roundabout to the 12 o'clock direction.

The traveling vehicle HV confirms classification information (micro roundabout, small roundabout, one-lane roundabout, two-lane roundabout, spiral roundabout, planar roundabout, three-dimensional roundabout, etc.) of the roundabout to be currently entered using pre-built map information. Alternatively, the traveling vehicle HV may use a camera to recognize signs and identification codes (e.g., QR codes) around the road, and to confirm information on the roundabout. Alternatively, the traveling vehicle HV may confirm information on the roundabout to be currently entered through communication with an RSU R.

Since the traveling vehicle HV intends to travel according to the traveling route as described above, the traveling vehicle HV needs to travel in the first lane and enter the roundabout in consideration of the classification information (spiral roundabout) of the roundabout. This is because only exit to the 3 o'clock direction is allowed in case of entering the roundabout by traveling the second lane. Therefore, in case that a driver has a driving control authority of the traveling vehicle HV and the traveling vehicle HV has not been traveling in the first lane until the time point of entering the roundabout (example: a predetermined distance from the crosswalk located before entering the roundabout, e.g., 300 meters), a notification is provided to the driver of the traveling vehicle HV to inform that the driver needs to perform the lane change to the first lane. In this case, the driver may perform the lane change to the first lane to pass through the roundabout for entering the roundabout from the 6 o'clock direction and exiting from the roundabout to the 12 o'clock direction. Alternatively, in case that the traveling vehicle HV has the driving control authority and has not been traveling in the first lane until the time point of entering the roundabout due to traffic congestion on the first lane or unusual circumstances (e.g. vehicle breakdown on the first lane or accident between vehicles, etc.), the traveling vehicle HV performs to enter the first lane in an area in which entering the first lane is allowed. Alternatively, the driving control authority of the traveling vehicle HV is switched (from the vehicle to the driver) so that the driver may allow the traveling vehicle HV to enter the first lane by manually controlling the traveling behavior.

Referring to FIG. 2A, the traveling vehicle HV has not yet entered the roundabout, and a first vehicle RV1 has entered the roundabout with the first lane from the 9 o'clock direction. In case that the traveling vehicle HV and the first vehicle RV1 are each equipped with a V2X function, the traveling vehicle HV and the first vehicle RV1 may exchange mutual traveling information (location information, route information, traveling information such as heading angle, etc., for example, the first vehicle may inform that the first vehicle intends to enter the roundabout from 9 o'clock direction and exit from the roundabout to the 12 o'clock direction) through communication between the traveling vehicle HV and the first vehicle RV1. Alternatively, the traveling vehicle HV and the first vehicle RV1 may communicate with the RSU R to transmit/receive traveling-related information.

In case that the first vehicle RV1 is not equipped with the V2X function, the traveling vehicle HV may receive information on the first vehicle RV1, which enters the roundabout and is traveling, from the RSU R. In this case, a reliability level for the traveling route of the first vehicle RV1 may be lower than that of the case in which the traveling route is directly received from the first vehicle RV1 equipped with the V2X function. Because the traveling route of the first vehicle RV1 received from the RSU R is information estimated through the traveling behavior (lane entered, current heading angle, etc.) of the first vehicle, there may be the case in which a driver of the first vehicle ignores the traveling guide in the roundabout and travels (for example, the driver enters the first lane from the 9 o'clock direction and performs the lane change to the second lane at the 6 o'clock and exits from the roundabout to the 3 o'clock direction). Therefore, instead of calculating a collision risk simply using the traveling route information on the other vehicle and determining its own traveling behavior, the traveling vehicle HV may control its own behavior by setting different weights for each scenario in which the traveling route information on the other vehicle is received (i.e., scenario of which entity sent the information) and applying the weights to the collision risk calculation.

In this case, regarding the reliability level, not only the classification information on the roundabout but also various types of traffic conditions may be considered. For example, it is assumed that the first vehicle RV1 is not equipped with the V2X function and information on the first vehicle RV1 entering the roundabout from the 9 o'clock direction is received from the RSU R. However, vehicles entering the roundabout from the 9 o'clock direction may enter the roundabout through either the first lane or the second lane or may exit from the roundabout to the 3 o'clock direction. That is, it may be predicted that a vehicle entering the roundabout through the first lane from the 9 o'clock direction will not perform the lane change to the second lane. In addition, it may be even more predicted that the vehicle will not perform the lane change to the second lane in the solid line section other than the dotted line section in the roundabout. However, it is assumed that a large number of vehicles which intend to exit from the roundabout to the 12 o'clock direction create a congestion situation in the first lane from the 6 o'clock direction to the 3 o'clock direction in the roundabout. When the first vehicle RV1 has entered the roundabout with the first lane from the 9 o'clock direction and intends to exit from the roundabout to the 3 o'clock direction, the first vehicle RV1 is highly likely to perform the lane change to the second lane, and the predicted behavior for the lane change may be predicted using the heading angle, etc. of the first vehicle. Therefore, even the information that the first vehicle RV1 with the same specification has entered the roundabout at the same direction (the 9 o'clock direction) is received from the RSU R, it is desirable to control the traveling behavior of the traveling vehicle HV by comprehensively considering the classification information on the roundabout and traffic situation information in the roundabout.

Referring to FIG. 2B, the traveling vehicle HV receives traveling information on the first vehicle RV1 from the first vehicle RV1 or the RSU R. and waits until the first vehicle RV1 exits from the roundabout. Further, as illustrated in FIG. 2C, when the first vehicle RV1 passes a predetermined traveling point in the roundabout (the predetermined traveling point may be set variably through the classification information on the roundabout, the route information on the traveling vehicle, etc.), the traveling vehicle HV enters the roundabout and travels along the intended route. For example, in the situation of FIG. 2B, in case that the first vehicle RV1 has informed the traveling vehicle HV of its traveling route (the exit to the 3 o'clock direction) through the V2V communication and congestion has not occurred in the roundabout according to the traffic situation information in the roundabout received through the RSU R, the first vehicle RV1 is highly unlikely to perform the lane change to the second lane by suddenly braking. Accordingly, when the first vehicle RV1 passes the predetermined traveling point, the traveling vehicle HV enters the roundabout and travels along the intended route. In contrast, when the first vehicle RV1 is not equipped with the V2X communication function and traffic congestion is monitored in the first lane from the 6 o'clock direction to the 3 o'clock direction in the roundabout according to the traffic situation information in the roundabout received through the RSU R, the traveling vehicle HV) changes the predetermined traveling point (a point moved a little further to the 3 o'clock direction compared to the case described above) of the first vehicle RV1 to calculate the collision risk in preparation for the lane change possibility of the first vehicle RV1, and allows the traveling vehicle HV to safely enter the roundabout.

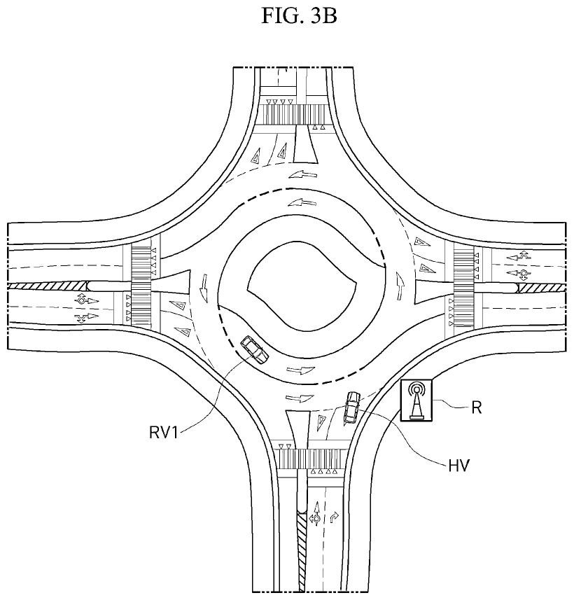

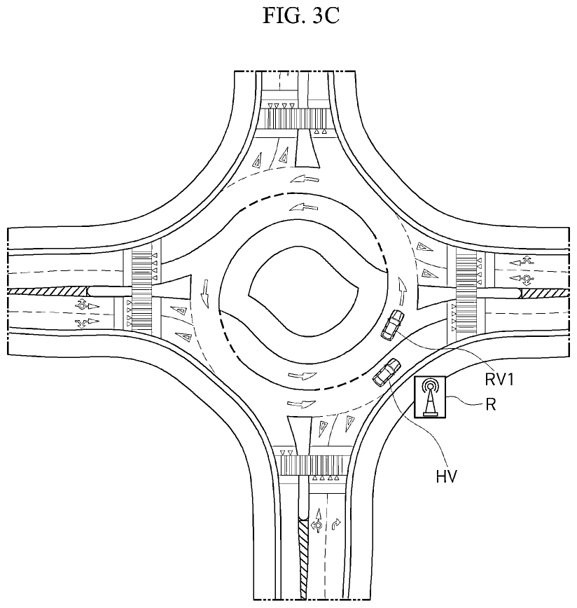

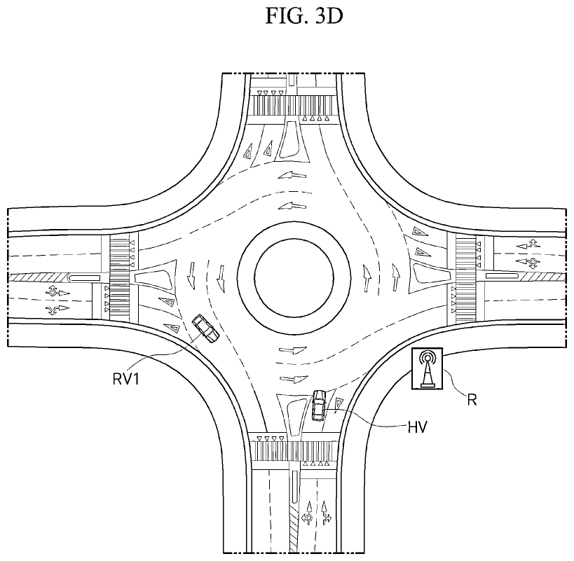

FIGS. 3A to 3C are views illustrating situations of controlling traveling of a vehicle entering the second lane in the spiral roundabout according to an embodiment of the present disclosure, and FIG. 3D is a view illustrating a situation of controlling traveling of a vehicle at a lane change suppression type roundabout according to an embodiment of the present disclosure.

A traveling vehicle HV is a vehicle that goes straight to enter the roundabout from the 6 o'clock direction and exit from the roundabout to the 3 o'clock direction.

The traveling vehicle HV confirms classification information on a roundabout to be currently entered using pre-built map information, camera recognition information, and a communication result with the RSU.

Since the traveling vehicle HV intends to travel according to the traveling route described above, the traveling vehicle HV needs to travel in the second lane and enter the roundabout in consideration of the classification information (spiral roundabout) of the roundabout. This is because only exit to the 12 o'clock direction or the 9 o'clock direction is allowed in case of entering the roundabout by traveling in the first lane. Therefore, in case that a driver has a driving control authority of the traveling vehicle HV and has not been traveling in the second lane until the time point of entering the roundabout (example: a predetermined distance from the crosswalk located before the roundabout, e.g., 300 meters), a notification is provided to the driver of the traveling vehicle HV to inform that the driver needs to perform the lane change to the second lane. In this case, the driver may perform the lane change to the second lane to pass through the roundabout for entering the roundabout from the 6 o'clock direction and exiting from the roundabout to the 3 o'clock direction. Alternatively, in case that the traveling vehicle HV has the driving control authority and is not traveling in the second lane until the time point of entering the roundabout due to unusual circumstances of the second lane (e.g. vehicle breakdown or accident between vehicles on the second lane), the traveling vehicle HV enters the second lane in an area in which entering the second lane is allowed. Alternatively, the driving control authority of the traveling vehicle HV is switched (from the vehicle to the driver) so that the driver may allow the traveling vehicle HV to enter the second lane by manually controlling the traveling behavior.

Referring to FIG. 3A, the traveling vehicle HV has not yet entered the roundabout, and a first vehicle RV1 has entered the roundabout with the first lane from the 9 o'clock direction. In case that the traveling vehicle HV and the first vehicle RV1 are cach equipped with the V2X function, to the traveling vehicle HV and the first vehicle RV1 may exchange mutual traveling information (location information, route information, traveling information such as heading angle, etc., for example, the first vehicle may inform that the first vehicle intends to enter the roundabout from the 9 o'clock direction and exit from the roundabout to the 12 o'clock direction) through communication between the traveling vehicle HV and the first vehicle RV1. Alternatively, the traveling vehicle HV and the first vehicle RV1 may communicate with the RSU R to transmit/receive traveling-related information.

In case that the first vehicle RV1 is not equipped with the V2X function, the traveling vehicle HV may receive information on the first vehicle RV1, which enters the roundabout and is traveling, from the RSU R. In this case, a reliability level for the traveling route of the first vehicle RV1 may be lower than that of the case in which the traveling route is directly received from the first vehicle RV1 equipped with the V2X function. Because the traveling route of the first vehicle RV1 received from the RSU R is information estimated through the traveling behavior (lane entered, current heading angle, etc.) of the first vehicle, there may be the case in which a driver of the first vehicle ignores the traveling guide in the roundabout and travels (for example, the driver enters the first lane from the 9 o'clock direction and performs the lane change to the second lane at the 6 o'clock and exits from the roundabout to the 3 o'clock direction). Therefore, instead of calculating a collision risk simply using the traveling route information on the other vehicle and determining its own traveling behavior, the traveling vehicle HV may control its own behavior by setting different weights for each scenario in which the traveling route information on the other vehicle is received (i.e., scenario of which entity sent the information) and applying the weights to the collision risk calculation.

In this case, regarding the reliability level, not only the classification information on the roundabout but also various types of traffic conditions may be considered. For example, it is assumed that the first vehicle RV1 is not equipped with the V2X function and information on the first vehicle RV1 entering the roundabout from the 9 o'clock direction is received from the RSU R. However, vehicles entering the roundabout from the 9 o'clock direction may enter the roundabout through either the first lane or the second lane or may exit from the roundabout to the 3 o'clock direction. That is, it may be predicted that a vehicle entering the roundabout through the first lane from the 9 o'clock direction will not perform the lane change to the second lane. In addition, it may be even more predicted that the lane change to the second lane will not be performed in the solid line section other than the dotted line section in the roundabout. However, it is assumed that a large number of vehicles which intend to exit from the roundabout to the 12 o'clock direction create a congestion situation in the first lane from the 6 o'clock direction to the 3 o'clock direction in the roundabout. When the first vehicle RV1 has entered the roundabout with the first lane from the 9 o'clock direction and intends to exit from the roundabout to the 3 o'clock direction, the first vehicle RV1 is highly likely to perform the lane change to the second lane, and the predicted behavior for the lane change may be predicted using the heading angle, etc. of the first vehicle. Therefore, even though the information that the first vehicle RV1 with the same specification has entered the roundabout at the same direction (the 9 o'clock direction) is received from the RSU R, it is desirable to control the traveling behavior of the traveling vehicle HV by comprehensively considering the classification information on the roundabout and the traffic situation information in the roundabout.

Referring to FIG. 3B, when the traveling vehicle HV receives a notification from the first vehicle RV1 that the first vehicle will exit from the roundabout to the 12 o'clock direction and receives a notification from the RSU R that the traffic flow is smooth in the roundabout, the traveling vehicle HV controls the traveling behavior to enter the roundabout and exit from the roundabout to the 3 o'clock direction. As illustrated in FIG. 3C, the vehicles may travel along mutually predicted traveling routes and thus safely travel in their own lanes in the state where there is no collision risk.

Meanwhile, when the first vehicle RV1 is not equipped with the V2X communication function and traffic congestion is monitored in the first lane from the 6 o'clock direction to the 3 o'clock direction in the roundabout according to the traffic situation information in the roundabout received through the RSU R, the traveling vehicle HV changes the predetermined traveling point (a point moved a little further to the 3 o'clock direction compared to the case described above) of the first vehicle RV1 to calculate the collision risk in preparation for the lane change possibility of the first vehicle RV1, and allows the traveling vehicle HV to safely enter the roundabout.

Referring to FIG. 3D, the first vehicle RV1 is a vehicle that entered the roundabout through the second lane from the 9 o'clock direction, and is likely to perform the lane change in the dotted line section of the roundabout. Therefore, since the possibility that the other vehicle will perform the lane change in the dotted section of the lane change suppression type roundabout is greater than the possibility that the other vehicle will perform the lane change in the solid section of the spiral roundabout, the traveling vehicle HV calculates a collision risk by setting different weights according to each situation, and accordingly performs to travel according to the traveling behavior control scenario in which the collision risk is equal to or lower than a predetermined reference.

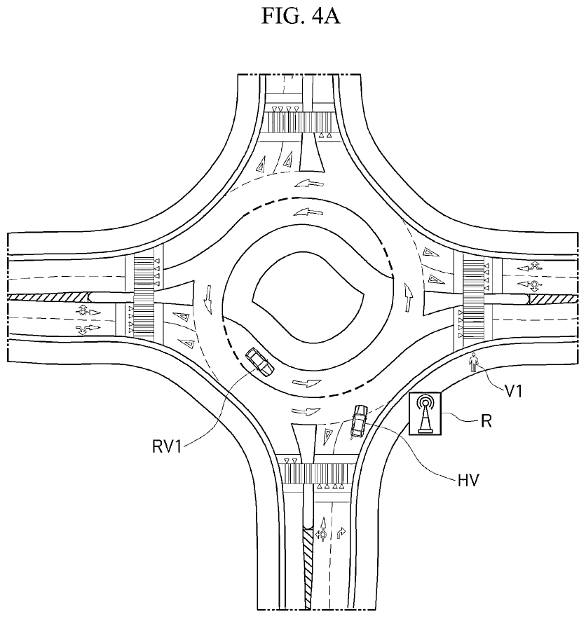

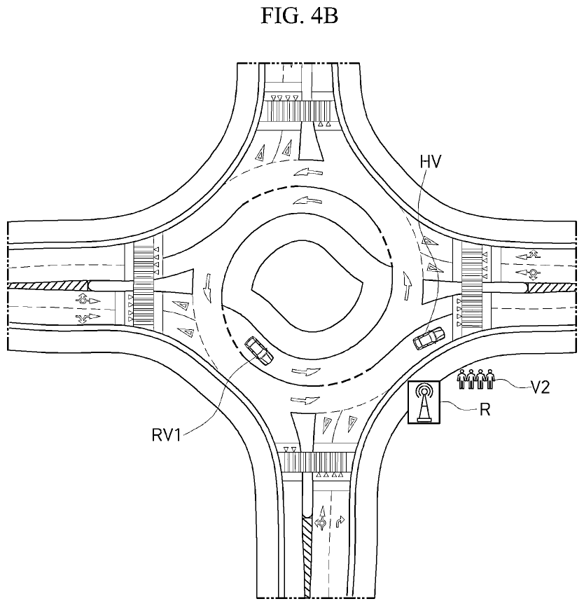

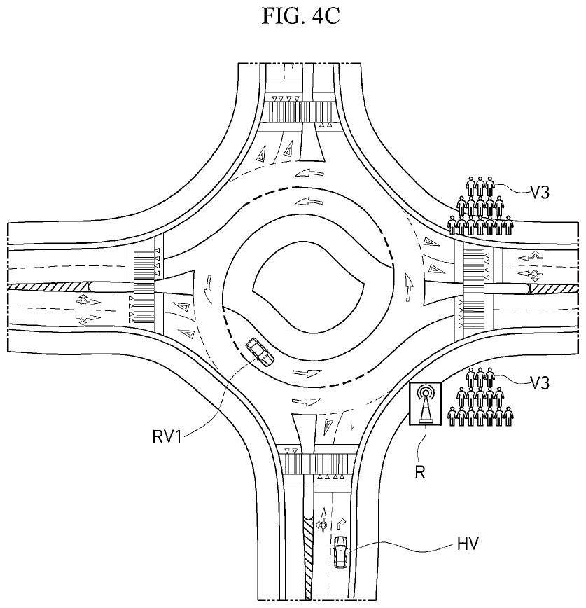

FIGS. 4A to 4C are views illustrating situations of controlling traveling of vehicles on the basis of situation information on a crosswalk area in the spiral roundabout according to an embodiment of the present disclosure.

In consideration of surrounding environment information on an object in a crosswalk area placed in a direction in which the traveling vehicle exits from the roundabout, a traveling vehicle HV performs traveling negotiation with a device of the object, or receives a traveling negotiation coordination result of an RSU to control a traveling behavior for passing the crosswalk. In this case, the traveling vehicle HV controls a traveling behavior using a traveling negotiation result determined according to the congestion level of the object waiting to cross or crossing the crosswalk area.

Referring to FIG. 4A, a first VRU V1 is a single object, and after the traveling vehicle HV enters the roundabout, a distance between the traveling vehicle HV and a crosswalk is equal to or greater than a predetermined reference value (e.g., 20 meters). In this case, the traveling vehicle HV communicates with a terminal possessed by the first VRU V1 or receives a traveling negotiation result from the RSU, so that the first VRU V1 crosses the crosswalk first, and then the traveling vehicle HV controls the traveling behavior to exit from the roundabout to the 3 o'clock direction after the first VRU V1 has completely crossed the crosswalk. This is because there are no other pedestrians waiting to cross the crosswalk except for the first VRU V1, there is no congestion situation in the roundabout, and the distance between the traveling vehicle HV and the crosswalk at the 3 o'clock direction is equal to or greater than a predetermined distance, and therefore the possibility of an accident in the case in which the first VRU V1 crosses the crosswalk first and then the traveling vehicle HV exits from the roundabout to the 3 o'clock direction is significantly lower than that in other cases (e.g., the case in which the order of crossing and traveling is reversed), and a time taken for the traveling vehicle HV to pass through the roundabout is equal to lower than a predetermined reference (e.g., 30 seconds).

Referring to FIG. 4B, a second VRU V2 has a congestion level of “2”, and has a higher congestion level than that in FIG. 4A. The distance between the traveling vehicle HV and the crosswalk after the traveling vehicle HV enters the roundabout is less than a predetermined reference value (e.g., 20 meters). In this case, the traveling vehicle HV communicates with a terminal possessed by the second VRU V2 or receives a traveling negotiation result from the RSU, so that the traveling vehicle HV exits from the roundabout first to the 3 o'clock direction, and the second VRU V2 crosses the crosswalk after the traveling vehicle HV has passed through the roundabout. The second VRU V2 is not waiting in front of the crosswalk, but is walking to the crosswalk at a predetermined distance (e.g., 10 meters) to wait for crossing the crosswalk, and the distance between the traveling vehicle HV and the crosswalk at the 3 o'clock direction is less than a predetermined distance. Therefore, the traveling behavior is controlled so that the traveling vehicle HV exits from the roundabout first to the 3 o'clock direction without stopping suddenly in front of the crosswalk.

Referring to FIG. 4C, a third VRU V3 has a congestion level of “3” and has a higher congestion level than those in FIGS. 4A and 4B. Since the traveling vehicle HV has not yet entered the roundabout, the traveling vehicle HV does not enter the roundabout until the third VRU V3 has all crossed the crosswalk, and either waits in a safe area such as a yield point or travels slowly up to the crosswalk.

By using VRU-related information which includes speed and direction information on the VRU, the behavior of the VRU is analyzed, for example, to control the traveling behavior to confirm whether there is the VRU suddenly jumping into the crosswalk and then to exit from the roundabout through the crosswalk.

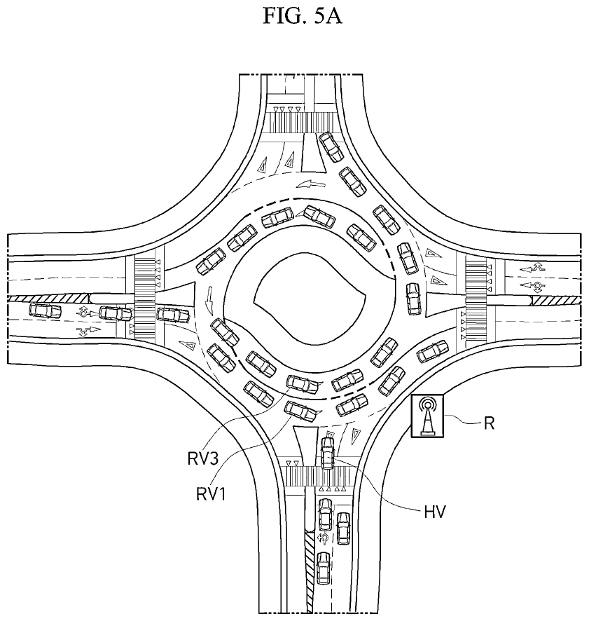

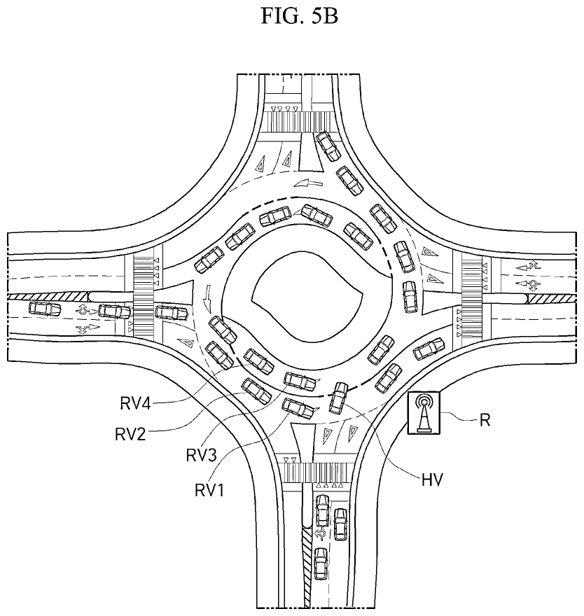

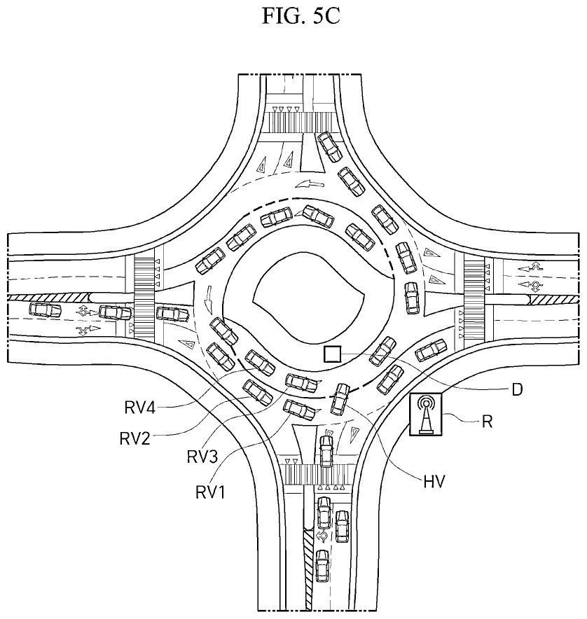

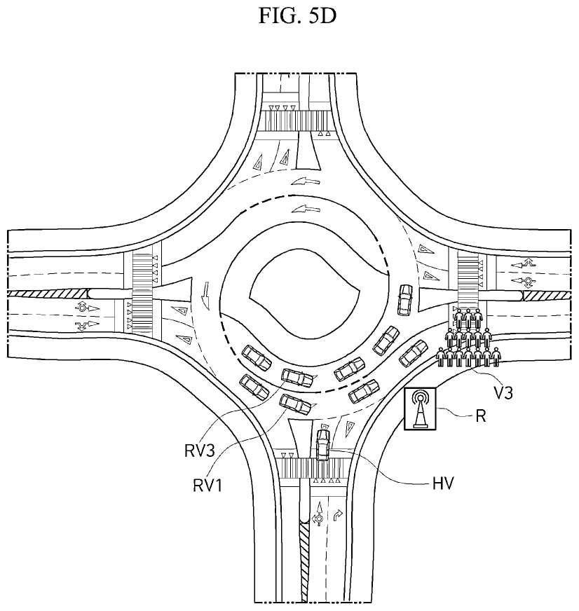

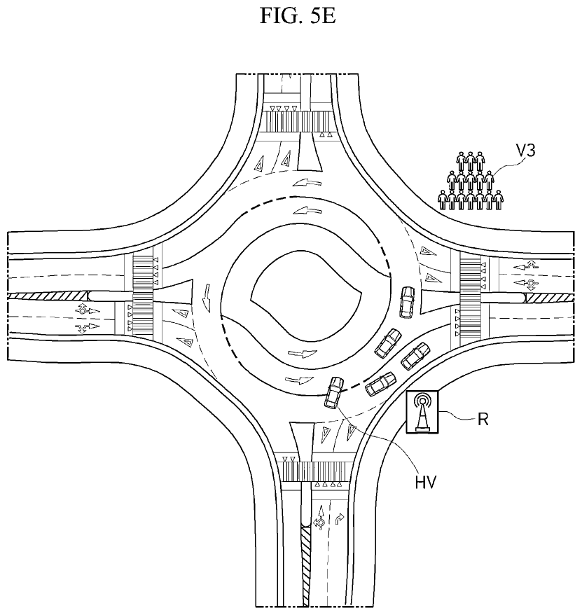

FIGS. 5A to 5E are views illustrating situations of controlling traveling of vehicles in a congestion situation in the spiral roundabout according to an embodiment of the present disclosure.

Referring to FIG. 5A, a congestion situation occurs in the roundabout due to vehicles entering the roundabout from the 9 o'clock and the 6 o'clock directions. It is assumed that a first vehicle (RV1) and a third vehicle (RV3) are each equipped with the V2X communication function. According to the existing guidelines, a traveling vehicle HV needs to yield to a vehicle that is traveling in the roundabout. Therefore, the traveling vehicle HV may not enter the roundabout until all the congestion situation is resolved. Therefore, the traveling guidelines in the roundabout is amended for mutually appropriate yields rather than unconditional yields, through a traveling negotiation coordination request of the traveling vehicle (HV) that temporarily stops before entering the roundabout, a traveling negotiation coordination result which is transmitted by the intervention of the RSU, or traveling negotiations between vehicles, and accordingly, the traveling behavior control in the roundabout is performed.

Referring to FIG. 5B, the first vehicle RV1 and the third vehicle RV3 travel at a predetermined distance from the rear of the preceding vehicle in their own traveling lanes in a congestion situation, and then stop temporarily, and the traveling vehicle HV enters the roundabout. In this case, the first vehicle RV1 and the third vehicle RV3 turn on their emergency lights to inform drivers of a second vehicle RV2 and a fourth vehicle RV4 that the first vehicle RV1 and the third vehicle RV3 are yielding to the traveling vehicle HV, the second vehicle RV2 and fourth vehicle RV4 each not being equipped with the V2X communication function. The traveling vehicle HV in case of traveling negotiations between vehicles or the RSU R in case of traveling negotiation coordination receives location and route information of a vehicle equipped with the V2X communication function from the corresponding vehicle, and, receives information on a vehicle that is not equipped with the V2X communication function, the information being obtained and shared by another vehicle which is located in the surrounding area of the corresponding vehicle and equipped with the V2X communication function. A notification unit D placed in the central traffic island displays a traveling negotiation coordination result of the RSU R so that the drivers of the vehicles RV2 and RV4 not equipped with the V2X communication function may recognize the traveling negotiation coordination result. Such notification unit D is disposed in a predetermined edge area within the central traffic island, and In consideration of the location information on the vehicles RV2 and RV4 each not equipped with the V2X communication function, the display surface of the notification unit D may be driven to rotate, or may be driven to rotate while the notification unit D moves along the rail.

Referring to FIG. 5C, the traveling vehicle HV receives cause information on the congestion situation in the roundabout (pedestrian V3 crossing the crosswalk at the 3 o'clock direction) from the RSU R, and enters the roundabout as illustrated in FIG. 5E when the congestion situation is determined to be a temporary congestion situation and then resolved. The RSU (R) may preemptively transmit traffic situation information in the roundabout to the traveling vehicle (HV) intending to enter the roundabout, or transmit traffic situation information in the roundabout in response to a request for a traveling negotiation coordination from the traveling vehicle (HV).

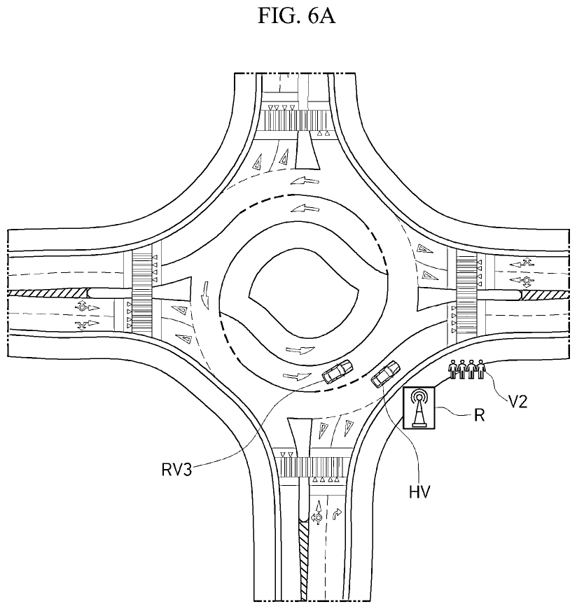

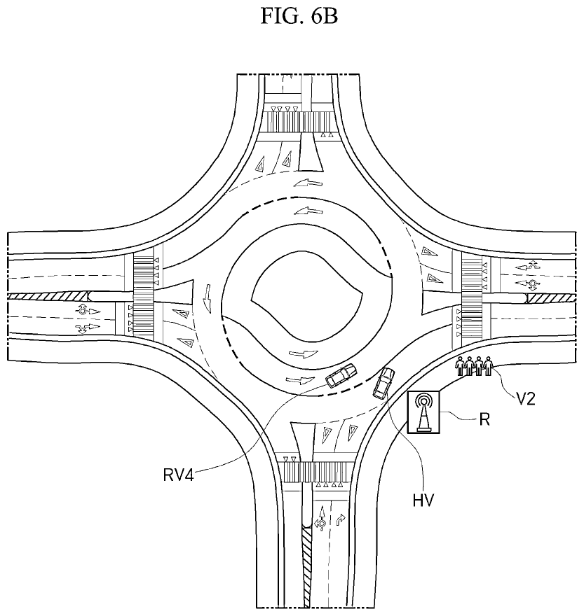

FIGS. 6A and 6B are views illustrating situations of controlling travels of vehicles in the spiral roundabout depending on whether the other vehicle is equipped with a V2X function according to an embodiment of the present disclosure.

Referring to FIG. 6A, the traveling vehicle HV predicts a behavior of a VRU using VRU recognition information and controls a traveling behavior of the traveling vehicle HV in the roundabout according to a result of the prediction. The traveling vehicle HV receives VRU-related information from at least one of a device of a VRU V2 and an RSU R recognizing the VRU (V2), and the VRU-related information includes behavioral information on crossing the crosswalk or waiting to cross the crosswalk. The traveling vehicle HV controls a traveling behavior to temporarily stop in front of a crosswalk in case that a pedestrian waiting to cross the crosswalk is recognized, and transmits a notification message for the temporary stop to the surroundings. A third vehicle RV3 equipped with the V2X communication function recognizes the temporary stop situation of the preceding traveling vehicle HV through the notification message, and also stops temporarily in front of the crosswalk.

Referring to FIG. 6B, an ACK message regarding the notification message transmitted by the traveling vehicle HV is not received from a fourth vehicle RV4 not equipped with the V2X communication function. Therefore, the traveling vehicle HV controls the traveling behavior to inform the fourth vehicle RV4 (a vehicle that travels in the lane next to the traveling vehicle and is likely to exit from the roundabout to the traveling direction, that is, to the 3 o'clock direction). In this case, the traveling vehicle HV controls the traveling behavior to turn the heading angle within a predetermined angle within the traveling lane toward a lane closer to the fourth vehicle RV4, or turns on the turn signal lighting so that the traveling vehicle HV supports the safe driving of a driver of the fourth vehicle RV4 according to the traveling behavior of the preceding traveling vehicle HV in the next lane even in case that the driver of the fourth vehicle RV4 is not aware of a blind spot situation.

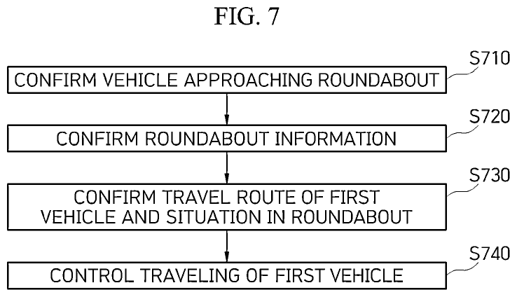

FIG. 7 is a flowchart illustrating a method of controlling traveling of a vehicle in a roundabout according to an embodiment of the present disclosure.

In step S710, the RSU confirms whether there is a vehicle approaching a roundabout within a predetermined distance using a V2X, a camera, a radar, and the like, and confirms whether the vehicle is equipped with a V2X terminal through I2V communication. The RSU assigns an ID to a general vehicle not equipped with the V2X terminal, and tracks and predicts the traveling direction in the roundabout (using cameras, lidar, etc.). In addition, the RSU assigns an ID to a vehicle equipped with the V2X terminal.

In step S720, a procedure for confirming roundabout information is performed, and in step S730, a procedure for confirming the traveling route of a first vehicle HV and a situation in the roundabout is performed, and in step S740, a traveling control of the first vehicle is performed. For example, when it is confirmed in step S720 that the roundabout has a separate right turn lane, and it is confirmed in step S730 that a vehicle approaching the roundabout turns right and needs to be guided to travel in the second lane, step 740 is performed to make the vehicle to exit from the roundabout by turning right after entering the roundabout. When it is confirmed in step S720 that the roundabout does not have a separate right turn lane, or it is confirmed in steps S720 and S730 that the first vehicle HV does not turn right in the roundabout with a separate right turn lane, in step S730, it is confirmed whether there is a vehicle traveling in the roundabout and it is determined whether it is possible to enter the roundabout. In case that there is a vehicle traveling in the roundabout, it is determined whether to request a travel negotiation from the RSU by confirming whether there is a congestion situation in the roundabout. In case that a V2X terminal is equipped in the other vehicle RV, a traveling negotiation between vehicles may be performed. As the traveling negotiation is completed, or as a traveling negotiation coordination result is received, in step S740, the vehicle enters the roundabout at an authorized time point and exits from the roundabout along the intended route. During the attempt to enter a roundabout, in step S730, it is confirmed whether a VRU is crossing or waiting to cross the crosswalk in an exit direction, and a V2P traveling negotiation is performed in case that the VRU has a device capable of performing communication, and in case that the VRU does not have a device capable of performing communication, the traveling behavior control of the first vehicle HV in step S740 is performed according to the traveling negotiation coordination of the RSU. In case that it is confirmed in step S730 that the VRU has crossed the crosswalk, or it is confirmed that the VRU is away by a predetermined distance or longer from the crosswalk, the first vehicle HV passes through the crosswalk area and finally exits from the roundabout, in step S740.

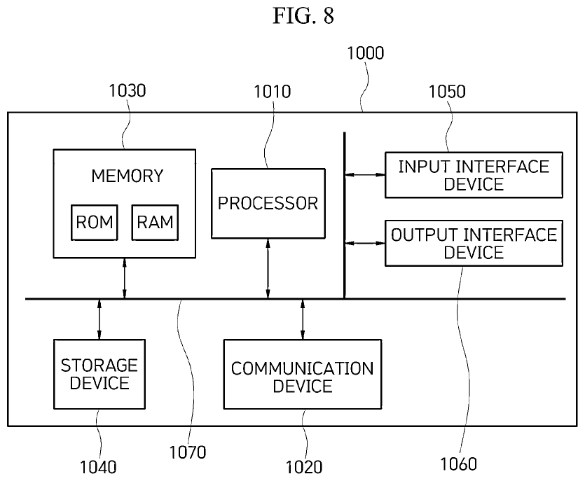

FIG. 8 is a block diagram illustrating a computer system for implementing the method according to an embodiment of the present disclosure.

Referring to FIG. 8, a computer system 1000 may include at least one of a processor 1010, a memory 1030, an input interface device 1050, an output interface device 1060, and a storage device 1040, which communicate with one another via a bus 1070. The computer system 1000 may also include a communication device 1020 coupled to a network. The processor 1010 may be a central processing unit (CPU) or a semiconductor device that executes instructions stored in the memory 1030 or storage device 1040. The memory 1030 and storage device 1040 may include various types of volatile or nonvolatile storage media. For example, the memory may include read only memory (ROM) and random entering memory (RAM). In the embodiment of the present disclosure, the memory may be located inside or outside the processor, and the memory may be connected to the processor through various already known means. The memory is various types of volatile or nonvolatile storage media, and, for example, memory may include read-only memory (ROM) or random entry memory (RAM).

Therefore, the embodiment of the present disclosure may be implemented as a method implemented in a computer, or as a non-transient computer-readable medium in which computer-executable instructions are stored. In one embodiment, when executed by the processor, the computer readable instruction may perform a method according to at least one aspect of the disclosure.

The communication device 1020 may transmit or receive a wired signal or a wireless signal.

In addition, the method according to the exemplary embodiment of the present disclosure may be implemented in the form of program instructions executable by means of various computer means and then written in a computer-readable medium.

The computer-readable medium may include program instructions, data files, data structures, or the like, in a stand-alone form or in a combination thereof. The program instructions recorded in the computer-readable medium may be designed and configured specifically for the embodiment of the present disclosure or may be publicly known and available to those skilled in the field of computer software. A computer-readable recording medium may include a hardware device configured to store and execute program instructions. For example, the computer-readable recording medium may be magnetic media such as hard disks, floppy disks and magnetic tapes, and optical media such as CD-ROMs and DVDs, a magneto-optical medium such as a floptical disk, ROM, RAM, or flash memory. Program instructions may include high-level language codes that may be executed by a computer using an interpreter, etc., as well as machine language codes made by a compiler.

Although the embodiments of the present disclosure have been described in detail above, the right scope of the present disclosure is not limited thereto, and it should be construed that many variations and modifications made by those skilled in the art using the basic concept of the present disclosure, which is defined in the following claims, will also belong to the right scope of the present disclosure.

What is claimed is:

1. An apparatus for controlling traveling of vehicles in a roundabout, the apparatus comprising:
a receiver configured to receive classification information on a roundabout which a traveling vehicle approaches and surrounding environment information;
a memory configured to store a vehicle traveling control program for the roundabout; and
a processor configured to execute the program to:
determine a traveling negotiation target according to the classification information on the roundabout, the surrounding environment information, and route information on the traveling vehicle, and
control a traveling behavior of the vehicle in the roundabout according to a traveling negotiation result.

2. The apparatus of claim 1, wherein the receiver is configured to recognize the classification information on the roundabout using at least one of communication information with a road side unit (RSU), map information, and camera recognition information.

3. The apparatus of claim 1, wherein the receiver is configured to obtain an ID given by the RSU, and the ID is used as identification information when the RSU coordinates a traveling negotiation.

4. The apparatus of claim 1, wherein the processor is configured to determine an entering lane for the roundabout using the classification information on the roundabout and the route information, and transmit a traveling command signal to travel in the corresponding entering lane.

5. The apparatus of claim 1, wherein in consideration of the surrounding environment information on an object in a crosswalk area placed in a direction in which the traveling vehicle exits from the roundabout, the processor is configured to perform a traveling negotiation with a device of the object, or receive a traveling negotiation coordination result of the RSU to control a traveling behavior for passing the crosswalk.

6. The apparatus of claim 5, wherein the processor is configured to control the traveling behavior using a traveling negotiation result determined according to a congestion level of the object waiting to cross or crossing the crosswalk area.

7. The apparatus of claim 1, wherein the processor is configured to:
control the traveling behavior using the surrounding environment information on a congestion situation in the roundabout, and
control the traveling behavior for entering the roundabout by performing a traveling negotiation with another vehicle with a collision risk that is equal to or greater than a predetermined value or receiving a traveling negotiation coordination result of the RSU, depending on whether another vehicle has the V2X communication function.

8. The apparatus of claim 1, wherein the processor is configured to:
receive location and predicted route information on another vehicle from another vehicle or the RSU and
control the traveling behavior of the traveling vehicle by calculating a collision risk with another vehicle using weights differently set according to the classification of the roundabout.
